(19) United States
(12) Patent Application Publication
(10) Pub. No.: US 2010/0204070 A1
(43) Pub. Date: Aug. 12, 2010

(54) LOW DENSITY COMPOSITE PROPPING AGENTS

(76) Inventors: Gilles Orange, Soisy Sous Montmorency (FR); Jean-Francois Estur, Saint Genis Laval (FR); Didier Tupinier, Assieu (FR)

Correspondence Address: BUCHANAN, INGERSOLL & ROONEY PC, POST OFFICE BOX 1404, ALEXANDRIA, VA, 22313-1404, US

(21) Appl. No.: 12/666,812

(22) PCT Filed: Jul. 4, 2008
(86) PCT No.: PCT/EP2008/058707

§ 371 Date: Apr. 19, 2010

(30) Foreign Application Priority Data
Jul. 6, 2007 (FR) 0704916

(51) Int. Cl. C09K 8/588; C09K 8/60

(52) U.S. Cl. 507/221; 507/219

(57) ABSTRACT

Composite propping agents of low density and of high mechanical strength are based on a thermoplastic polymer matrix, in particular having low compressive deformation at high temperatures are especially useful in the field of well fracturing for the recovery of sludges, liquids and gases present in underground reservoirs, and in particular in the field of the extraction of hydrocarbons, such as crude oil or natural gas.

The present invention relates to a composite having low density and of high toughness based on a thermoplastic polymer in particular having high mechanical performance at high temperature, in particular in compression. The invention also relates to a method for preparing said composite, and also to uses thereof, especially in the field of the field of the recovery of sludges, liquids and gases present in the underground reservoirs, and in particular in the field of the extraction of oil and gas, such as crude oil or natural gas.

In a large number of fields of activity, it may be necessary to have materials with high mechanical performance, characterized in particular by very good compressive strength and low compressive deformation, not only at ambient temperature, but also at high temperatures.

Depending on the field of application, solutions have been devised and are used today. However, some technical solutions require further improvement, because they only partially or imperfectly meet the requisite needs. In particular, the density of these materials is generally high due to the use of large quantities of filler.

This is the case for example in the field of the recovery of sludges, liquids and gases present in underground reservoirs, and in particular in the field of the extraction of oil and gas, such as crude oil or natural gas, and more particularly for drilling well fracturing techniques.

Well fracturing is a process used today to increase the extraction yields of sludges, liquids and gases present in natural underground reservoirs. Thanks to the cracks (fractures) created in the underground rock, this technique provides access to a larger quantity of products of interest to be extracted.

Various systems are used to maintain a flow of the various sludges, liquids and gases, in particular oil and gas, during the fracturing (formulations in the presence of surfactants, gel and various polymers, solid particles, and other). The fracturing process involves two successive steps: i) injecting a fluid at a sufficient flow rate and pressure to cause the breakage of the geological formation, thereby creating cracks (fractures) in the reservoir (rock), and ii) installing materials, generally in the form of particles, used for their capacity to prop said cracks in the geological formation at the fractures.

When the fluid pressure is removed, the stresses present in the geological formation tend to close the fractures. The particles must accordingly have sufficient mechanical strength to withstand these fracture closer stresses and thereby maintain openings in these fractures and thereby some conductivity in the geological formation. Fractures treated in this way have sufficient permeability for the flow of the products of interest, such as sludges, liquids, gases, in particular oil and gas, and their recovery.

One difficulty is the placement of these particles in the fractured zones; this is achieved by the fracturing fluid. The particles must be compatible with the fluid: good dispersion, no settling. The compatibility with the fluid requires products having a density close to that of the fluid, that is a specific gravity close to 1.2.

Among the most commonly used propping materials, mention can be made of calibrated sand having a typical grain size between about 1 mm to about 3 mm, with a relatively narrow size distribution (low dispersivity), and a specific gravity close to 2.8 at ambient temperature. Mention can also be made of ceramics in the form of pellets of varying density.

The advantage of these products is their very high stiffness and mechanical strength, including at high temperature. However, this type of product has low toughness, giving rise to the formation of fines during use, in particular in fracturing, by flaking under the effect of the pressure applied. These fines can thus clog the porosity created at the fractures, thereby sharply decreasing the conductivity of the fracture and hence reducing the flow of the products to be extracted, in particular the oil and gas, more particularly, the crude oil. Due to their high stiffness, these particles can also be embedded in the geographic formation and thus disappear from the fracture plane.

Another drawback of these products is their high density. These propping agents are generally placed by pumping/injection via a brine having a specific gravity of about 1.2; it is therefore necessary to add blending agents (surfactants, thickeners, gels, etc.) to place these particles and avoid problems of demixing or settling, and these blending agents must then be removed.

Other materials recently developed and marketed as propping agents are polymer or composite particles, in particular pellets of thermoset resins or even polymer-coated low density particles. These materials have a low density, with a specific gravity generally between about 0.9 and about 2, at ambient temperature. This low density feature gives them excellent compatibility with the pumping/fracturing processes, without the need for other additives. However, these materials have drawbacks, in particular their substantially high production cost (due to the preparation process), and the limitation of their mechanical strength, particularly at high temperature and under high confining pressure.

It is therefore an object of the present invention to propose a material having a low density and good mechanical properties, in particular compressive strength, at high temperature, in particular a material which can withstand crushing in the fractures formed during the fracturing of wells for extracting sludges, liquids and/or gases, in particular drilling wells for oil and gas, crude oil or natural gas.

More particularly, it is an object of the present invention to overcome the various drawbacks of the materials available today, in particular the drawbacks of the propping agents used in the fracturing of wells for extracting fossil materials, present in underground reservoirs.

It is a further object of the present invention to propose a material having good mechanical properties, in particular compressive strength, at high temperature, and also good hydraulic conduction properties.

Other further objects will appear from the description of the invention that follows.

The Applicant has now discovered that the abovementioned objectives are fully or partly achieved, thanks to the material of the invention.

The present invention thus relates to the use of a material comprising at least one thermoplastic polymer matrix in which at least one reinforcing filler of the precipitated silica type is dispersed, for the field of the extraction of oil and gas, such as crude oil or natural gas.

The present invention also relates to the use of reinforcing fillers of the precipitated silica type to improve the mechanical properties of a thermoplastic polymer matrix for the preparation of a material used in the field of the extraction of oil and gas, such as crude oil or natural gas.

This material is used in particular as propping agent in drilling well fracturing techniques, for its capacity to prop or support the cracks obtained during the fracturing of the wells. The material of the invention can also be used as a gravel pack used in the field of oil and gas extraction.

This material has the following properties in particular: a parallelepipedic test specimen having a cross section of 3.5 mm×3.5 mm and a height of 4 mm, obtained by injection of said material, and placed under crushing stress with a force of 0.9 kN distributed over the whole area of 3.5 mm×3.5 mm of said specimen:
has a deformation ε_{0.9} at 110° C. lower than or equal to 40%, preferably lower than 35%, even more preferably lower than 30%, advantageously lower than 25%; and
a yield stress σ_{y} at 110° C. higher than 6 MPa, preferably higher than 8 MPa, advantageously higher than 10 MPa.

As stated below, the polymer matrix may also be consolidated by an agent that can modify its viscoelastic behavior, possibly up to its crosslinking. The material of the present invention is further characterized in particular by a density lower than or equal to 2.5, preferably lower than or equal to 2.2, advantageously lower than or equal to 2, ideally lower than or equal to 1.5, even more preferably lower than or equal to 1.35.

Thus, the material of the invention which comprises at least one thermoplastic polymer matrix and a reinforcement in the form of dispersed fillers, has a high crushing strength at temperatures above 50° C. and under pressures exceeding 125 bar, with a specific gravity lower than 2.5.

The thermoplastic polymer used as a matrix for the material of the invention may be any known thermoplastic polymer, or any mixture of two or more known thermoplastic polymers, and may for example be selected from polyamides, polyesters, polyolefins, and others. The molecular weight Mn of the thermoplastic polymer is generally higher than 10 000, preferably higher than 12 000, even more preferably higher than 15 000.

The thermoplastic material used in the material of the invention is advantageously selected from polyamides, among which mention can be made of aliphatic polyamides, semi-aromatic polyamides and, more generally, linear polyamides obtained by polycondensation between a saturated aliphatic or aromatic diacid, and a saturated aromatic or aliphatic primary diamine, the polyamides obtained by condensation of a lactam, an amino acid, or polyamides obtained by condensation of a mixture of these various monomers.

More precisely, these polyamides may, for example, be hexamethylene polyadipamide, polyphthalamide obtained from terephthalic and/or isophthalic acid, copolyamides obtained from adipic acid, hexamethylene diamine and caprolactam.

According to one embodiment of the invention, the thermoplastic polymer is advantageously a polyamide, generally prepared by synthesis by polycondensation, for example selected from polyamides 6, polyamides 6.6, polyamides 11, polyamides 12, copolyamides 66/6, copolyamides 6/66, copolyamides comprising at least 80% by weight of polyamide 6 motifs, or at least 80% by weight of copolyamide 66, semi-aromatic polyamides, such as those known by the trade names Amodel® or Nylon HTN, polyamides T6 and polyamides 4.6.

According to a preferred embodiment of the invention, the thermoplastic polymer matrix comprises a polyamide, advantageously a polymide 6.6, alone or in a mixture with one or more other thermoplastic polymers.

In addition to the thermoplastic matrix, the material according to the present invention comprises at least one reinforcing filler of the precipitated silica type.

A precipitated silica is an amorphous silica which can be prepared by a precipitation reaction of a silicate, such an alkali metal silicate like sodium silicate for example, with an acidizing agent such as sulfuric acid, with the production of a suspension of precipitated silica, and then, usually, separation, in particular by filtration, with the production of a filter cake, of the precipitated silica obtained, and finally drying, generally by spray drying. Any method can be employed for preparing the precipitated silica, in particular, the addition of an acidizing agent to a silicate bottom, the simultaneous total or partial action of an acidizing agent and silicate on a water and silicate bottom. Mention can be made in particular of the processes mentioned in the references EP0520862, EP0670813, EP0670814 and EP0966207. Preferably, a highly dispersible precipitated silica (HDS) is used.

The precipitated silica is advantageously in the form of substantially spherical pellets, in particular having a mean grain size distribution (D₅₀) higher than or equal to 50 μm, preferably between 50 and 300 μm. The precipitated silica may be in the form of granules, generally substantially parallelepipedic, in particular having a size of at least 1 mm. The silica may also be in the form of powder, generally having a mean grain size (D₅₀) higher than 10μ.

In the thermoplastic matrix, the precipitated silica is generally dispersed and is mostly found, that is at least 70% by volume of the total volume of precipitated silica, in the form of dispersed submicron-sized particles having a mean grain size (D₅₀) in particular between 10 and 1000 nm, more preferably between 50 and 250 nm.

The material may optionally comprise other reinforcing fillers such as:
oxides, such as glass, alumina, and others;
mixed oxides, for example kaolinite, talc, mica, wollastonite, diatoms, and others;
silicates, such as clays, cements, and others;
carbonates, for example of calcium, potassium, and others;
nitrides, for example silicon nitride, and others;
carbides, such as silicon carbide, and others; and from
carbon, ceramics, fly ash, artificial or natural, and others.

These fillers may have various morphologies, for example isotropic, platy, or acicular. The fillers may therefore be in the form of:
fibers, for example fibers of glass, aramid, polyvinyl alcohol;
fibers of thermoset material, such as natural or artificial fibers, for example jute fibers;
hollow or solid pellets, for example molecular sieves, ceramic, glass, and others;
powder, in particular for clays, kaolinite, talc, silica, aluminum, molecular sieves, fruit and vegetable peels in general, fruit kernels or sieves, for example walnut shells, cashew husks, coconut husks, and others.

The fillers may also be formed by modification or reaction in situ, after incorporation in the polymer of reactive fillers and/or precursors. For example, fillers of the calcium silicate or aluminate type can be incorporated in the polymer, giving rise in situ, by reaction with water, to a specific lattice of hydrates of a different type, size and morphology than the silicates initially introduced.

The mean grain size distribution (D₅₀) of these fillers is generally between about 1 μm and about 100 μm, advantageously between about 1 μm and about 50 μm. Submicron-sized fillers having a mean grain size between about 10 nm and about 1 μm, or even nanometer-sized fillers, can also be used, alone or in addition to other fillers, for example exfoliated clays. According to the type of application and the desired properties, it may also be advantageous to use polymer type reinforcing fillers, such as cellulose acetate, alone or in combination with one or more other fillers like those defined above.

As stated above, it is possible to use combinations of these various fillers or types of reinforcing elements in the thermoplastic polymer matrix of the material of the invention.

With the reinforcing fillers, the material of the present invention may optionally comprise one or more coupling agents for providing a degree of cohesion between the filler and the matrix. These coupling agents are well known to a person skilled in the art, and can, for example, be selected from silanes, esters of fatty acids, carboxylic acids, and others. As a type of silane, mention can be made of aminopropyltriethoxysilane, chloropropyltriethoxysilane and chloropropyltrimethoxysilane. Use can be made in particular of 0.5 to 20% by weight of coupling agent, compared to the weight of the precipitated silica, preferably between 2 and 15% by weight.

The material according to the present invention may also comprise at least one additive for modifying certain properties, in particular to improve the steps of use and/or shaping, to improve the thermal stability, to improve the oxidation stability, to improve the light stability, to modify the hydrophilic character, and others. These additives are generally additives commonly used for the production of thermoplastic polymer compositions and among them, mention can be made of lubricants, fire resistant agents, platicizers, nucleating agents, catalysts, toughness enhancing agents such as elastomers, optionally grafted, light and/or heat stabilizers, antioxidants, antistatics, dyes, matting agents, casting additives or other conventional additives. The additives usable in the material of the invention may thus be selected advantageously from plastizers, pigments, dyes, matting agents, fire retarding agents, crosslinking agents, thermal stabilizers, and others.

Additives for improving the quality of the filler-matrix interfaces, in particular fiber-matrix interfaces, may also be used. These additives are either incorporated in the polymer, or present on the fillers used for the reinforcement, or may be specially deposited on these fillers, by covering, coating, film-coating, among others.

The quantity of precipitated silica present in said material is between 1 and 25 volume %, preferably between 2 and 15 volume %, ideally between 2 and 12 volume %.

The quantity of fillers present in the material of the invention may vary within wide proportions and according to the intended use. This quality may be between 20 and 90 volume %, preferably between 20 and 60 volume %, in particular for fillers having a mean grain size between about 1 μm and about 100 μm.

For submicron-sized fillers, in particular for fillers having a structured morphology and a mean grain size between about 10 nm and about 1 μm, the quantity of fillers may advantageously be between 1 and 25 volume %, preferably between 2 and 20 volume %, preferably between 2 and 15 volume %, ideally between 2 and 12 volume %, all the percentages being expressed as the volume of fillers per volume of material. This corresponds approximately to weight proportions between 2 and 39.6% by weight, preferably between 3.8 and 32.9% by weight, preferably between 3.8 and 25.7% by weight, ideally between 3.8 and 21.1% by weight, all these percentages being expressed by weight of fillers per weight of material.

The material of the present invention may be prepared by the usual techniques for processing thermoplastic polymers, usually by mixing, in the molten state or not, of the thermoplastic polymer matrix, with the fillers, in particular the precipitated silica, and optionally the additives, and other components of the material. The material of the present invention may also be prepared by mixing the fillers directly in the matrix polymerization medium, in particular when said fillers are not likely to be degraded during the polymerization and when they are inert to the polymerization process.

The invention relates in particular to a method for preparing the material in which at least one thermoplastic polymer is mixed, in the molten state or not, with a precipitated silica, and optionally other fillers and additives; said precipitated silica is advantageously in the form of substantially spherical pellets having a mean grain size (D₅₀) preferably between 50 and 300 μm.

In each of the alternative methods for preparing the material, the mixing of the fillers with the matrix or the polymerization medium is sufficient to obtain a good state of dispersion of the fillers in the matrix, in particular, and especially in the case in which the fillers could be in the form of aggregates, the mixing must ensure a deaggregation and a good dispersion of the fillers. It may for example be useful to first prepare a masterbatch with a high filler content, typically between 20 and 35 volume %; the masterbatch is then diluted and formulated to obtain the desired mixture.

The material thus obtained can be used to produce pieces by any method known to a person skilled in the art, in particular by granulation, calendering, injection, molding, injection molding, pressing, and others.

It is thus possible for example to prepare granules, chips, pellets, ingots, all spherical, flat, ovoid shapes, in the form of drops, prisms, parallelepipeds, cylinders, pads, and others. According to one embodiment and advantageously for drilling well fracturing applications, the material of the invention is advantageously in the form of granules, pellets and/or cylinders, flattened or not.

In particular, when the material is in the form of substantially spherical or ellipsoidal pellets, they can be prepared by a recessed-surface die plate process, such as described for example in U.S. Pat. No. 2,918,701 and U.S. Pat. No. 3,749,539 or even in patent application US2005/0035483. This process uses a die head provided with holes and fed with the thermoplastic matrix in the molten state, comprising the fillers and optionally one or more additives as described above. The underwater die head is provided with a rotary knife-holder of which the blades cut the molten material issuing from the die holes, and the water bath in which the cutting head is submerged allows for rapid cooling of the pellets formed.

The material of the present invention, as defined above, is characterized by its crushing strength, and its low deformation under stress, at high temperature. Said material is further characterized, in an embodiment of the invention, by its density, with a specific gravity generally lower than or equal to 2.5, measured by the method described below.

The measurements and preparations are carried out in a controlled-temperature laboratory (23° C.). The weighings are carried out on a balance having a sensitivity of 0.0001 gram (Type Sarthorius CP 3245). A 20 mL volumetric flask filled with deionized water is weighed (M0). At least 20 granules taken at random are weighed (M1) and then introduced into the volumetric flask, of which the level is adjusted to 20 mL by removing water after the removal of any bubbles. The volumetric flask is then weighed (M2). The density of the granules is obtained by the formula:

Density=M1/[M1−(M2−M0)]

The high temperature compressive strength tests of the objects normally used for oil well applications consist for example in measuring the permeability and conductivity of a fluid across a compacted powder bed, for example according to standard API RP61. This test requires the use of a complex installation, and the duration of this test is also long, generally longer than two weeks.

Thus the Applicant has developed a specific test and a specific apparatus for subjecting a set of objects of the present invention to a hot crushing stress. This apparatus consists of a specific test cell and a standard tensile testing machine. The test cell serves to evaluate the materials of the invention in a temperature range extending from ambient temperature to a temperature exceeding 250° C., and under pressures of up to 250 MPa (2500 bar).

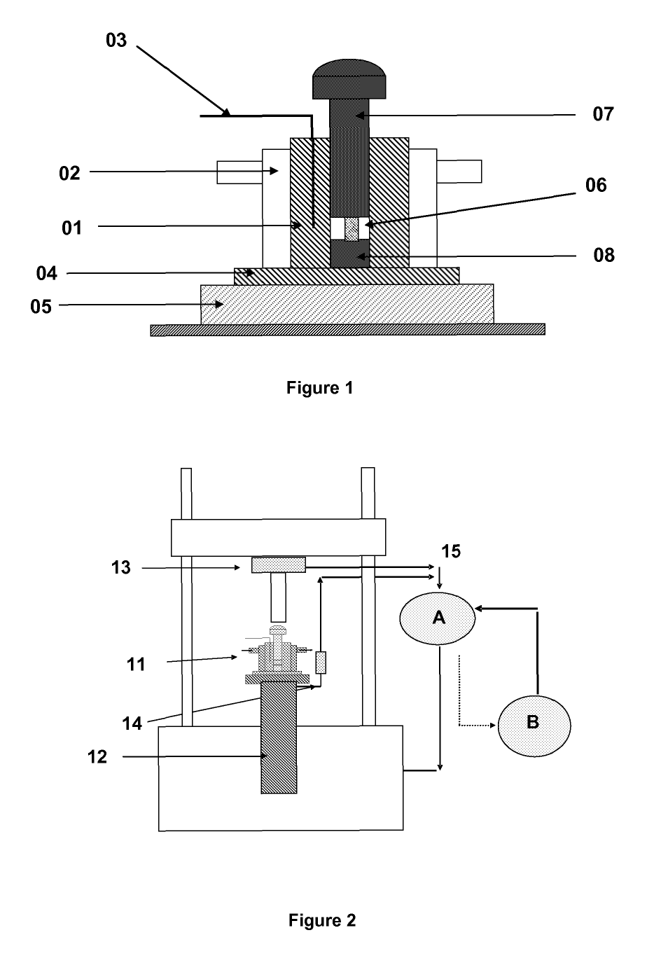

The cell used is shown in FIG. 1, in which a very thick ground treated steel cylinder 01 rests on a steel plate 04. The cell is heated by oil circulation 02, and the temperature is measured by a Pt 100 probe 03. The cell is placed on a steel base 05, provided with an insert for thermal insulation (not shown). The sample 06 is placed on a ground treated steel counter-plunger 08. The force is applied to a sample by a steel cylinder 07 having a diameter of 15 mm and made from ground treated steel.

The cell is placed on the cylinder of a tensile testing machine interlocked in a closed loop (Schenck-Trebel RMC 100), as shown in FIG. 2. The force applied is measured by a class 0.1 (60 kN) force cell 13, and the displacement of the piston 12 is monitored by a displacement transducer LVDT+/−10 mm class 0.1 (Linear Displacement Transducer) 14. The “force” and “displacement” signals are recovered 15 for the acquisition and control of the machine (A: PID closed loop controller/B: function and acquisition generator).

Prior to the evaluations of the materials, a test is conducted at the test temperature (110° C.) without a sample, in order to determine the deformation of the assembly. A curve Zₘ=f(P) is thus measured, where Zₘ is the displacement given by the displacement transducer and P the force applied. During a test on material, the measured displacement is: Z=f(P). The real displacement Z_{c} is then calculated, using a correction due to the deformation of the assembly, with the equation:

Z_{c}=Z−Zₘ, for each value of the force P.

The tests are all conducted at constant temperature, to avoid any problem associated with thermal expansion effects.

A sample is introduced into the cell at ambient temperature, and a prestress is then applied (typically 10 N). The cell is then raised to the test temperature, the prestress being kept constant via the force interlock loop of the machine.

The crushing tests are conducted with force interlock on parallelepipedic test specimens having a height of 4 mm (hₒ) and a cross section of 3.5 mm×3.5 mm (Sₒ).

The deformation ε is defined by the ratio of the corrected displacement Z_{c} to the height hₒ of the sample before crushing: ε=Z_{c}/hₒ.

An apparent stress can be calculated by the equation σ=P/Sₒ, where Sₒ is the area of the sample before crushing. This stress corresponds to the real stress as long as the behavior of the material is linear elastic. At high temperature, the plastic deformation occurs fairly rapidly, leading to a wide variation in the area of the sample and hence in the real stress, which becomes different from the apparent stress.

The yield stress σ_{y} is defined from the deviation from linearity on the Force=f(deformation) curve at the test temperature (110° C.), according to standard ISO 604.

It has now been discovered that the material of the present invention, presented in the form of a test specimen having a cross section of 3.5 mm×3.5 mm and a height of 4 mm, placed under crushing stress with a force of 0.9 kN uniformly distributed over the whole cross section of said specimen:
has a deformation ε_{0.9} at 110° C. lower than 40%, preferably lower than 35%, even more preferably lower than 30%, advantageously lower than 25%, and even lower than 20%, or even lower than 10% in certain cases; and
a yield stress σ_{y} higher than 6 MPa, preferably higher than 8 MPa, advantageously higher than 10 MPa.

Another test can be conducted to measure the performance of the materials of the invention. A given mass of objects according to the invention is introduced into the cell at ambient temperature, and a prestress is then applied (typically 10 N). The cell is then heated to the test temperature, the prestress being kept constant via the force interlock loop of the machine. The initial porosity Po (zero load of 10 N preload) is calculated by the following equation:

Pₒ=(Vc−Vp)/Vc

where Vc is the total volume of the cell at Po (area of the cell×height of the bed of particles); and Vp is the volume occupied by all the objects (mass/density).

The crushing tests are carried out with force interlock at about 500 N/min, with 4 levels: 3653 N, 7306 N, 9742 N, and 12178 N (corresponding to stresses in the cell of 3000, 6000, 8000 and 10 000 PSI). The duration of the plateaux is about 40 minutes. The displacement Z is measured continuously, as a function of time.

The residual height ε is defined by the difference between the initial height of the particle bed and the corrected displacement Zc. The residual volume Vr is defined as the area of the cell multiplied by the residual height.

The residual porosity P is calculated by the equation: P=(Vr−Vp)/Vo where Vo is the area of the cell multiplied by the height of the particle bed at initial P (Po), Vp the volume occupied by the particles, and Vr the area of the cell multiplied by the residual height ε at the corresponding pressure. The data are presented in the form Porosity=function of the pressure applied to the cell (at the test temperature).

It has now been discovered that the products of the present invention, in the form of pellets having a diameter of between 0.25 and 3 mm uniformly distributed over the whole cross section of said measurement cell for a concentration of between 0.02 lb/ft² (9.76 mg/cm²) and 0.15 lb/ft² (0.07 g/cm²), serve to obtain a residual porosity P higher than 15% under a pressure of 10 000 PSI at 110° C. Products having such a crushing strength at high temperature make it possible to consider uses in various fields, in particular where products are required subject to high crushing stresses, in media in which the temperature is high, at least much higher than the ambient temperature, but without having significant deformations and for a controlled density.

It should be observed that the materials according to the present invention are viscoplastic materials, that is to say, they display neither cracks nor flakes when subjected to compression, in particular at the high stresses and temperatures defined above.

Thus, and according to another object, the present invention relates to the use of a material as defined above in the form of calibrated particles, for example substantially spherical or ellipsoidal or substantially in the form of cylinders, having a diameter between 0.1 mm and 3 mm, preferably between 0.3 mm and 2 mm, in techniques for fracturing drilling wells, in particular of crude oil or natural gas.

As stated above, these small calibrated particles used in drilling well fracturing techniques (commonly called propping agents) are introduced at the fractures, and remain in place at the end of the fracturing process. These particles then maintain a degree of opening of the cracks, thereby facilitating a flow of oil or gas.

The customary advantages of these propping agents are essentially good mechanical properties, in particular high crushing strength, and chemical stability in the conditions of use, typically at 50° C. to 175° C. for a pressure of 12.5 MPa (125 bar) to 100 MPa (1000 bar). The environment is generally a mixture of salt, water and oil and gas.

Thus, the invention also relates to a well fracturing method using at least one material of the invention, preferably the material as defined above, in the form of calibrated particles, for example substantially spherical or ellipsoidal or substantially in the form of cylinders, having a diameter between 0.1 mm and 3 mm, preferably between 0.3 mm and 2 mm.

The fracturing method according to the invention is characterized by the pumping of a fluid from the land surface to an underground reservoir, containing crude oil or natural gas in particular, at a pressure and a sufficiently high flow rate to cause the formation of cracks or fractures. In order to keep the fractures open, the material for the invention, advantageously in the form of calibrated particles as defined above, is mixed with said fluid and injected into the underground reservoir to fill the underground fracture, and thereby cause a propping of said reservoir.

According to another aspect, the material of the invention, in particular when used as a propping agent in the form of pellets, ellipses and/or cylinders, and because of its slight deformation under crushing stress in the fractures, allows a good flow of the fluids to be extracted from the underground reservoirs.

The calibrated particles of the material acting as a propping agent keep a permeable passage open, through which the crude oil or natural gas can flow to the drilling well(s), thereby increasing access to the entire reservoir. The conductivity of the fracture is a critical data element: it depends on the permeability of the bed of particles and on the thickness of this bed.

The quantity of material of the invention used as propping agent during a fracturing may vary in wide proportions, and is generally between a few metric tons, or a few tens of metric tons, to several hundred metric tons, for example 50 metric tons and 200 metric tons.

According to a further aspect, the material of the invention can also be used as a gravel pack. For this purpose, the material of the invention, advantageously in the form of calibrated particles as defined above, is introduced by pumping into the underground reservoir to act by a filtration mechanism, in order to minimize the flow of fine particles of rock, sand, and other impurities liable to be present in the reservoir, in the sludges, liquids and gases to be extracted from the well. Such a gravel packing operation requires a few thousand kg to a few tens of thousands of kg, for example 5 metric tons to about 10 metric tons of material according to the invention.

The present invention also relates to a drilling well comprising at least one material as defined above.

The material according to the present invention may be conditioned in several different ways, in solid form or in a suspension, depending on the quantity used, the method of transport, storage, and other factors.

Advantageously, the material of the invention is packed in bags of about 1000 kg.

Exemplary embodiments of materials according to the present invention, and also the results of crushing strength tests on said materials, are presented below, and are intended to illustrate the invention, but without adding any limitation thereto.

### Experimental

Definition of Raw Materials

The examples below present various materials prepared from a polyamide 6.6 type polymer matrix (Technyl® 26AE1, sold by Rhodia), in which various fillers have been introduced.

These fillers are characterized by their density and their mean grain size (D₅₀), as indicated in Table 1 below:

TABLE 1

| | | | Specific | Size |
|---|---|---|---|---|
| | Source | Grade | gravity | (D₅₀) μm |
| Kaolinite | Imerys | Polarite | 2.7 | 2 |
| | | 102A | | |
| Mica | CMMP | MU247 | 2.85 | 60 |
| Wollastonite | Nyco | M3 | 2.7 | 2.5 |
| Precipitated | Rhodia | Z1165MP | 2.2 | ** |
| silica* | | | | |
| Anhydrous | Dickerhoff | Mikrodur | 2.9 | 3.5 |
| calcium | | RU | | |
| silicate | | | | |
| (micro-cement) | | | | |
| Blown glass | 3M | S 60 HS | 0.6 | 30 |
| pellets | | | | |

*A filler-matrix coupling agent such as silane has optionally been used with the precipitated silica: aminopropyltriethoxysilane (Silquest A 1101). The dose is typically 1% by weight of silane with regard to the filler.
**: The silica is in the form of substantially spherical pellets (mean grain size about 250 μm).

Preparation of Materials

### 1. Incorporation of Fillers in the Polymer

The various fillers considered were incorporated in the polyamide using an internal laboratory mixer with 15 mL capacity type Microcomputer (DMS MIDI 2000) with nitrogen flushing.

The mixing is carried out via 2 taper screws with recirculation of the products in the internal chamber at a speed of 150 rpm.

The temperature setpoint of the mixer is 285° C. The mixing with internal recirculation is continued until a uniform mixture is obtained (about 5 minutes), and the product is extruded from the mixer.

### 2. Preparation of Injected Parts

The mixture is then recovered and introduced into a mini-injection press (DSM). The injection is carried out with a piston temperature of 290° C. for a mold temperature of 100° C.

The parts obtained are parallelepipedic rods having the dimensions 63×13×4 mm.

Characterization of Materials

### 1. Preparation of Test Specimens

The rods measuring 63×13×4 mm are cut with a diamond saw at low speed (Struers) to obtain parallelepipedic samples measuring 3.5×3.5×4 mm with parallel sides and a good surface texture. They are then maintained for about 8 hours at ambient temperature (23° C.) with 50% relative humidity. The density is measured by the procedure described above.

### 2. Mechanical Characterization (Compressive Test on 3.5×3.5×4 mm Cube)

The samples are evaluated for crushing strength using the test cell and the tensile test machine described above and shown in FIGS. 1 and 2. The relative humidity is 50% at ambient temperature, before conditioning to the test temperature.

Once the sample is introduced, the cell is heated to the test temperature (110° C.). The oil temperature is maintained at the desired temperature by a thermocryostat (Lauda Proline RP845). The oil used is a silicone oil (Rhodorsil 550).

After being held for 1 hour at the desired temperature under preload (10 N), the tests are performed. The Force=f(displacement) curves are recorded, and the correction is made to have a corrected displacement of the sample: Z_{c}=f(P).

The apparent elastic modulus E is calculated in the elastic domain. The apparent yield stress σ_{y} can also be estimated, expressed in MPa, calculated according to standard ISO 604, that is the stress corresponding to the deviation from linearity (or the stress corresponding to a deformation ε of 0.1%).

A characteristic loading level was defined: it corresponds to an applied pressure of 735 bar (73.5 MPa). The corresponding force as defined in the test described above is 0.9 kN. For this loading level at 110° C., the deformations ε_{0.9} of the various samples are calculated.

The crushing tests are conducted in force interlock at 0.5 N/s on parallelepipedic samples with a height hₒ (4 mm) and cross section sₒ (3.5×3.5 mm).

The results are given in Table 2 below:

TABLE 2
Results of crushing tests (0.5 N/s) at 110° C. on samples
3.5 mm × 3.5 mm and 4 mm

| | | Rigidity or | | |
|---|---|---|---|---|
| | | apparent | Apparent | Deformation |
| | Specific | modulus | yield stress | ε_{0.9} for |
| Example | gravity | (GPa) | (MPa ± 0.5 MPa) | P = 0.9 kN (%) |
| C1/PA 6.6 | 1.12 | 0.410 | 12 | 45 |
| C2/PA 6.6 + | 1.47 | 0.450 | 11.5 | 38 |
| kaolinite (20% | | | | |
| vol) | | | | |
| C3/PA 6.6 + | 1.53 | 0.700 | 12 | 21 |
| mica (25% vol) | | | | |
| E1/PA 6.6 + | 1.25 | 0.825 | 15 | 17 |
| silica (15%) | | | | |
| C4/PA 6.6 + | 1.96 | 1.600 | 16 | 8 |
| mica (50%) | | | | |
| E2/PA 6.6 + | 1.26 | 0.850 | 16.5 | 12 |
| (silica + | | | | |
| silane) (15%) | | | | |
| C5/PA 6.6 + | 2 | 1.8 | 15.5 | 25 |
| micro-cement | | | | |
| (50%) | | | | |
| C6/PA 6.6 + | 1.2 | 0.44 | 12 | 40 |
| kaolinite | | | | |
| (18%) + glass | | | | |
| pellets (10%) | | | | |

The examples E are representative of the present invention; the examples C are representative of the prior art.

The results obtained clearly show that the unfilled polymer (PA 6.6) and the compositions comprising a low proportion of reinforcing filler are deformed very rapidly and inelastically at high temperature (110° C.), for relatively low force levels (200 N to 300 N).

For high quantities of reinforcing filler, typically above 20 vol %, in the case of fillers having a grain size higher than one micron, the behavior of the material is considerably modified with a larger elastic domain.

Results are obtained with the material based on polyamide 6.6 comprising 50 vol % of mica, or 50 vol % of micro-cement. Some submicron-sized fillers give rise to very advantageous behaviors, provided that these fillers are correctly dispersed. Thus with 15 vol % of precipitated silica, similar behavior is obtained to that obtained with 50% of micro-cement.

Preparation of Materials

For the introduction of the precipitated silica into the polyamide, a masterbatch is first prepared, and then taken up in a formulation by dilution. This serves to obtain a good deaggregation/dispersion of said fillers. The masterbatch was prepared from polymer PA 6.6 Technyl 26AE1 in the form of standard granules and precipitated silica in a content corresponding to 30% by weight (19% by volume) using a twin screw extruder equipped with recessed-plate die head, with a shear profile.

The masterbatch, in the form of coarse granules of about 5 to 10 mm is taken up in a formulation. A dilution is carried out by adding polymer PA 6.6 Technyl 26AE1 in the form of granules to obtain a final content of 20% by weight (12% by volume) of precipitated silica. The masterbatch and the polyamide granules are introduced at the inlet of a twin screw extruder equipped with a recessed-plate die head, with a shear profile. The recessed-plate die head cutting device serves to obtain pellets from the molten mixture having a spherical morphology and a mean diameter of 1.5 mm.

A second test was conducted in the conditions described above, with the addition of a coupling agent (chloropropyltrimethoxysilane). The liquid silane is impregnated in the masterbatch by simple mixing in a closed mixer before the dilution step. The content used in the example is 4% by weight compared to the precipitated silica. The recessed-plate die head cutting device serves to obtain pellets from the molten mixture having a spherical morphology and a mean diameter of 1.5 mm.

Characterization of Products

### 1. Density Measurement

The pellets obtained by the recess-plate die head cutting are dried at 40° C. in an oven. The density is measured by the method previously described.

### 2. Mechanical Characterization (Crushing of a Particle Bed)

The samples are evaluated for crushing strength using the test cell and the tensile test machine described above and shown in FIGS. 1 and 2. The relative humidity is 50% at ambient temperature, before conditioning to the test temperature. The quantity of product is set at 0.04 lb/ft² (0.0195 g/cm²).

Once the sample is introduced, the cell is heated to the test temperature (110° C.). The oil temperature is maintained at the desired temperature by a thermocryostat (Lauda Proline RP845). The oil used is a silicone oil (Rhodorsil 550).

After being held for 1 hour at the desired temperature under preload (10 N), the tests are performed. The Force=f(displacement) curves are recorded, and the correction is made to have a corrected displacement of the sample: Z_{c}=f(P).

The residual porosity Pr is calculated for each plateaux: 0, 3000, 6000, 8000, and 10 000 PSI (respectively 0, 207, 413, 551 and 690 bar).

The results are given in Table 3 below:

TABLE 3
Results of crushing tests at 110° C. on pellets containing 0.04 lb/ft²

| | | Porosity as a function of cell pressure (%) | | | | |
|---|---|---|---|---|---|---|
| | Specific | | 3000 | 6000 | 8000 | 10 000 |
| | gravity | 0 | PSI | PSI | PSI | PSI |
| C7/PA66 | 1.12 | 0.94 | 0.35 | 0.26 | 0.15 | 0.11 |
| C8/PA66 + | 1.47 | 0.95 | 0.39 | 0.26 | 0.21 | 0.19 |
| 40 wt % | | | | | | |
| kaolinite | | | | | | |
| E3/PA66 + | 1.26 | 0.93 | 0.36 | 0.23 | 0.18 | 0.15 |
| 20 wt % | | | | | | |
| silica | | | | | | |
| E4/PA66 + | 1.26 | 0.9 | 0.42 | 0.3 | 0.26 | 0.22 |
| 20 wt % | | | | | | |
| silica + | | | | | | |
| 2 wt % | | | | | | |
| coupling | | | | | | |
| agent | | | | | | |

The examples E are representative of the present invention; the examples C are representative of the prior art.

The results obtained clearly show that the unfilled polyamide 66 has a low density, with a specific gravity lower than 1.35, but on the contrary, a low residual porosity Pr at 10 000 PSI at 110° C. For large quantities of reinforcing filler, typically above 20 vol % in the case of conventionally used fillers, the behavior of the material is considerably modified. The residual porosity Pr at 10 000 PSI at 110° C. is higher than 0.15, but to the detriment of the density, with a specific gravity higher than 1.35.

On the contrary, the use of precipitated silica serves to obtain a very good low density and crushing strength compromise. Thus with 20% by weight of precipitated silica, a residual porosity Pr greater than 0.15 is obtained at 10 000 and 110° C., while maintaining the specific gravity below 1.26.

1.-18. (canceled)

19. A composite propping agent useful in well fracturing for oil and gas recovery, comprising a mechanically strong, low compressive deformation at both high and low temperatures, crush resistant viscoplastic thermoplastic polymer matrix having a reinforcing amount of at least one precipitated silica filler material dispersed therein, said composite propping agent having a specific gravity less than or equal to 2.5.

20. The composite propping agent as defined in claim 19, having a specific gravity less than or equal to 2.2.

21. The composite propping agent as defined in claim 19, having a specific gravity less than or equal to 2.

22. The composite propping agent as defined in claim 19, having a specific gravity less than or equal to 1.5.

23. The composite propping agent as defined in claim 19, having a specific gravity less than or equal to 1.35.

24. The composite propping agent as defined by claim 19, in which the material comprising the thermoplastic polymer matrix in which at least one precipitated silica reinforcing filler is dispersed, a parallelepipedic test specimen thereof having a cross section of 3.5 mm×3.5 mm and a height of 4 mm, obtained by injection of said material, and placed under a crushing stress with a force of 0.9 kN distributed over the entire area of 3.5 mm×3.5 mm of said specimen:
having a deformation ε_{0.9} at 110° C. lower than or equal to 40%; and
a yield stress σ_{y} at 110° C. higher than 6 MPa.

25. The composite propping agent as defined by claim 19, said at least one thermoplastic polymer having a molecular weight Mn higher than 10,000.

26. The composite propping agent as defined by claim 19, said at least one thermoplastic polymer comprising a polyamide, polyester or polyolefin.

27. The composite propping agent as defined by claim 26, said at least one thermoplastic polymer comprising a polyamide 6, polyamide 6.6, polyamide 11, polyamide 12, copolyamide 66/6, copolyamide 6/66, copolyamide comprising at least 80% by weight of polyamide 6, or at least 80% by weight of copolyamide 66, semi-aromatic polyamide T6 and/or polyamide 4.6.

28. The composite propping agent as defined by claim 19, said at least one precipitated silica comprising an amorphous silica prepared by the precipitation of a silicate with an acidizer, with the production of a suspension of precipitated silica, and then separation, optionally by filtration, with the production of a filter cake, of the precipitated silica obtained, and finally drying, optionally by spray drying.

29. The composite propping agent as defined by claim 19, said at least one precipitated silica comprising a highly dispersible silica (HDS).

30. The composite propping agent as defined by claim 19, said at least one precipitated silica comprising substantially spherical pellets, granules or a powder.

31. The composite propping agent as defined by claim 19, wherein the at least one precipitated silica is dispersed in the thermoplastic polymer matrix and is present, for at least 70% by volume of the total volume of precipitated silica, in the form of dispersed submicron-sized particles having a mean grain size (D₅₀) ranging from 10 to 1,000 nm.

32. The composite propping agent as defined by claim 19, wherein the quantity of precipitated silica present therein ranges from 1 to 25 volume %.

33. The composite propping agent as defined by claim 19, further comprising one or more coupling agents for providing a degree of cohesion between the filler and the matrix.

34. The composite propping agent as defined by claim 19, in the form of granules, chips, pellets, ingots, whether spherical, flat, ovoid, or otherwise, or in the form of drops, prisms, parallelepipeds, cylinders, pads or otherwise.

35. The composite propping agent as defined by claim 19, in the form of calibrated particles, substantially spherical or ellipsoidal or substantially in the form of cylinders, having a diameter ranging from 0.1 mm to 3 mm.

36. In a technique for the fracturing of crude oil or natural gas drilling wells, the improvement which comprises, as fracturing material therefor, the composite propping agent as defined by claim 19.

37. A drilling well employing at least one composite propping agent as defined by claim 19.
